(19) United States
(12) Patent Application Publication
(10) Pub. No.: US 2013/0149581 A1
(43) Pub. Date: Jun. 13, 2013

(54) ELECTRIC POWER TOOL

(71) Applicant: Shuji YOSHIKAWA, Anjo-shi (JP)

(72) Inventor: Shuji YOSHIKAWA, Anjo-shi (JP)

(21) Appl. No.: 13/665,378

(22) Filed: Oct. 31, 2012

(30) Foreign Application Priority Data
Dec. 9, 2011 (JP) 2011-270368

(51) Int. Cl. H01M 2/10

(52) U.S. Cl. 429/100

(57) ABSTRACT

In an electric power tool, a terminal base having a terminal plate attached thereto is provided in a battery holding portion formed in a housing, the terminal plate is slid and mounted on a battery pack, and a buffer material is interposed at least between the terminal base and the terminal plate. A through hole is formed in the terminal plate, and the terminal plate is attached to the terminal base with the through hole being filled with the buffer material.

### BACKGROUND OF INVENTION

This application claims the benefit of Japanese Patent Application Number 2011-270368 filed on Dec. 9, 2011, the entirety of which is incorporated by reference.

### TECHNICAL FIELD

The present invention relates to electric power tools in which a terminal base having a terminal plate attached thereto is provided in a battery holding portion formed in a housing and the terminal plate is slid and mounted on a battery pack.

### BACKGROUND ART

For example, General Catalog, Makita Corporation, October 2011, p. 16, (searched. on Dec. 8, 2011), URL:

http://www.makita.co.jp/product/ecatalog/sougou/index.html#16 discloses an electric power tool which includes a substantially cylindrical main body housing extending in the longitudinal direction, a handle portion protruding downward from the main body housing, and a battery holding portion provided at a distal end of the handle portion, and in which a battery pack is detachably mounted on the battery holding portion. In this electric power tool, a terminal base having terminal plates attached thereto is provided in the battery holding portion, and the terminal plates are slid and inserted into charging/discharging terminals placed in the battery pack by sliding the battery pack along the battery holding portion.

In this electric power tool, the terminal plates are insert-molded on the terminal base. Thus, if vibrations produced during operation of the electric power tool are transmitted to the battery holding portion through the main body housing, vibrations are transmitted to the terminal plates via the terminal base. Accordingly, during operation of the electric power tool, the terminal plates vibrate and rub against the charging/discharging terminals of the battery pack. Therefore, it may cause melting of the terminal plates. In order to suppress such melting of the terminal plates, a buffer member is interposed between the battery holding portion and the terminal base in an attempt to reduce transmission of vibrations to the terminal plates. However, the buffer member needs to be provided independently of the terminal base. Therefore, it has been desired to prevent melting of the terminal plates by a simple structure.

In another method to reduce transmission of vibrations to the terminal base, the terminal base provided in the battery holding portion was moved according to vibrations. However, such a mechanism of moving the terminal base according to vibrations needs to be individually designed according to the type of electric power tool, which may increase manufacturing cost of the electric power tool.

### SUMMARY OF THE INVENTION

The present invention was proposed in view of the above problems, and it is an object of the present invention to provide an electric power tool capable of suppressing melting of a terminal plate by an inexpensive, simple structure.

In a first aspect of the present invention, an electric power tool includes a battery holding portion formed in a housing, a terminal base provided in the battery holding portion and having a terminal plate attached thereto, a battery pack on which the terminal plate is slid and mounted, and a buffer material interposed at least between the terminal base and the terminal plate.

In a second aspect of the present invention according to the configuration of the first aspect, a through hole is formed in the terminal plate, and the terminal plate is attached to the terminal base with the through hole being filled with the buffer material.

In the electric power tool according to the first aspect of the present invention, the buffer material can reduce transmission of the vibrations from the terminal base to the terminal plate even if vibrations produced during operation of the electric power tool are transmitted to the housing. This can suppress rubbing of the terminal plate against the battery pack, and thus can suppress melting of the terminal plate. Moreover, it can be realized to suppress melting of the terminal plate only by the buffer material interposed at least between the terminal base and the terminal plate. Therefore, the structure that suppresses melting of the terminal plate can be inexpensively and easily implemented.

According to the second aspect of the present invention, the buffer material can be held between the terminal base and the terminal plate with the through hole in the terminal plate being filled with the buffer material. This can increase the strength in integrating the terminal plate with the buffer material.

### BRIEF DESCRIPTION OF THE DRAWINGS

FIG. 1 is a partially cut-away overall perspective view of an impact driver having terminal plates mounted on a battery pack according to an embodiment of the present invention.

FIG. 2 is an exploded perspective view of a main body housing and the battery pack which form the impact driver.

FIG. 3A is an overall perspective view of the terminal plates, FIG. 3B is an overall perspective view of the terminal plates having a buffer member formed integrally therewith, and FIG. 3C is a perspective view of a terminal base having the terminal plates attached thereto.

FIG. 4 is a side sectional view of the terminal base.

FIG. 5 is a perspective view showing an inner structure of the battery pack having the terminal plates mounted thereon.

### SUMMARY OF THE INVENTION

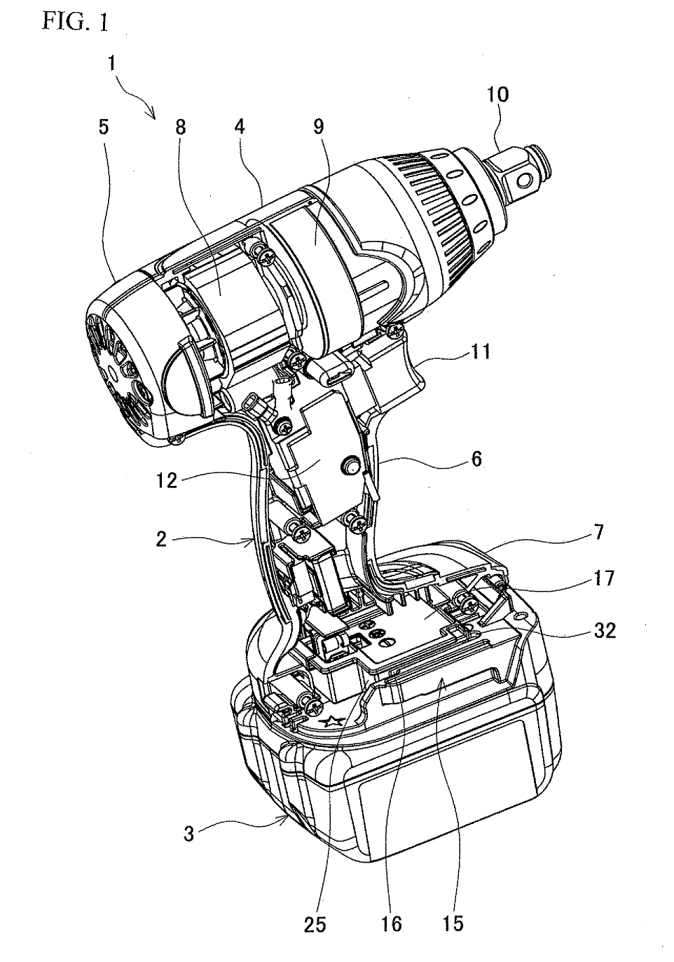

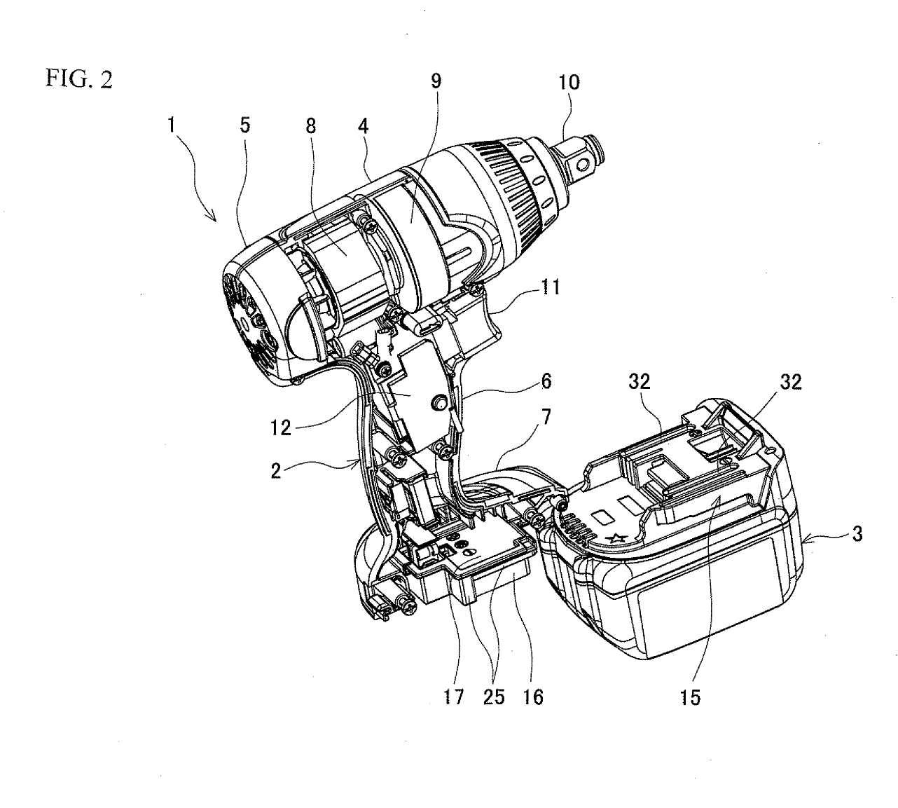

An embodiment of the present invention will be described with reference to FIGS. 1 to 5. As shown in FIGS. 1 and 2, an impact driver 1 includes a main body housing 2 and a battery pack 3. The main body housing 2 has a body portion 4, a rear cover 5, a handle portion 6, and a battery holding portion 7. The body portion 4 is formed in a substantially cylindrical shape, and extends in the longitudinal direction of the impact driver 1 (the lateral direction in FIGS. 1 and 2). A motor 8 is accommodated in the body portion 4. The rear cover 5 has a tubular shape that opens on a body portion 4 side of the rear cover 5, and is attached to a rear end of the body portion 4. The impact driver 1 is an example of the electric power tool of the present invention, and the main body housing 2 is an example of the housing of the present invention.

A hammer case 9 is mounted on the front (rightward in FIGS. 1 and 2) of the body portion 4. An impact mechanism and an anvil (not shown) disposed to protrude from a distal end face of the hummer case 9 are accommodated in the hammer case 9. The anvil is axially supported so as to rotate in the hammer case 9, and a socket holding portion 10 on which a tool and a socket can be mounted is provided at a distal end of the anvil. The impact mechanism converts rotation of the motor 8 to a rotational impact force, and transmits the rotational impact force to the tool and the socket.

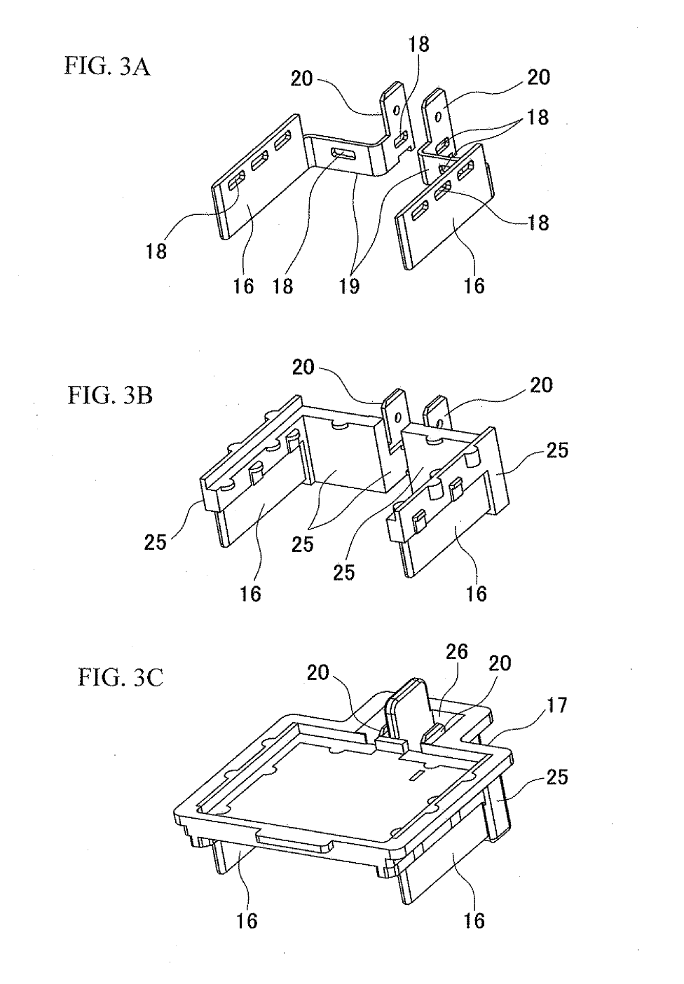

The handle portion 6 is connected to the body portion 4 so as to extend downward from the body portion 4. A switch 12 having a trigger 11 is accommodated in the handle portion 6. The battery holding portion 7 is formed at a lower end of the handle portion 6. Guide rails (not shown) extending in the longitudinal direction are formed at left and right lower ends of the battery holding portion 7. A pair of left and right slide rails 15, 15 (see FIG. 1) are provided on the battery pack 3 described below, and the guide rails hold the pair of left and right slide rails 15, 15 therebetween from outside when the battery pack 3 is mounted on the battery holding portion 7. A terminal base 17 (see FIGS. 2 and 3C) having terminal plates 16, 16 protruding downward therefrom is placed between the slide rails 15, 15 in the battery holding portion 7.

As shown in FIG. 3A, each terminal plate 16 has a rectangular shape having a short side in the vertical direction and a longer side in the longitudinal direction, and the terminal plates 16, 16 are placed parallel to each other so as to be separated from each other and to face each other in the lateral direction. A plurality of through holes 18 arranged in the longitudinal direction is formed in an upper part of each terminal plate 16. Positive and negative electrodes 20, which extend in the vertical direction and face each other, are connected to rear ends of the terminal plates 16, 16 via arm members 19 extending in the lateral direction. A through hole 18 is also formed in a central portion of each arm member 19 and a lower end of each electrode 20.

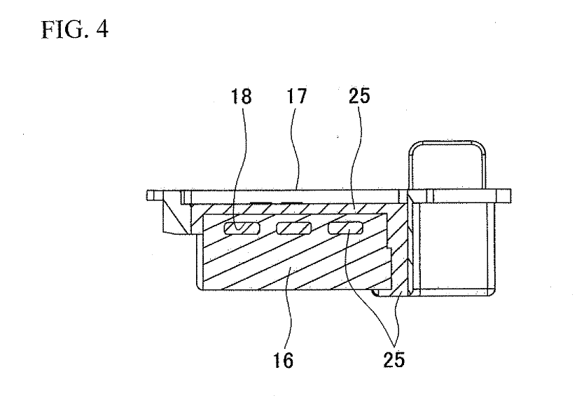

As shown in FIG. 3B, a buffer member 25 is integrally formed on an upper portion (an upper end and an upper surface portion) of each terminal plate 16 by double molding. The buffer member 25 is made of an elastomer having heat resistance and elasticity. In a process of the double molding, the elastomer is poured in a mold of the buffer member 25 so as to be integrally formed with the upper portion of each terminal plate 16 in a state of the through holes 18 in the terminal plate 16 being filled with the elastomer as shown in FIG. 4. As shown in FIG. 3B, the buffer member 25 is also integrally formed on a surface of each arm member 19 with the through hole 18 in the arm member 19 being filled with the elastomer, and the buffer member 25 is also integrally formed on a lower portion (a lower end and a lower surface portion) of each electrode 20 in a state of the through hole 18 in the electrode 20 being filled with the elastomer. The buffer member 25 of the arm member 19 and the buffer member 25 of the electrode 20 are formed continuously and integrally with the buffer member 25 of the terminal plate 16. The elastomer is an example of the buffer material of the present invention.

As shown in FIG. 3C, the terminal plates 16, 16 and the arm members 19, 19, which have the buffer member 25 integrally formed thereon by double molding as shown in FIG. 3B, are attached to the terminal base 17 made of a resin. Thus, the terminal plates 16, 16 and the arm members 19, 19 are attached to a lower surface of the terminal base 17 with the buffer members 25 interposed therebetween. The electrodes 20, 20 are accommodated in an electrode accommodating space 26 that opens in an upper surface of the terminal base 17. The switch 12 (see FIG. 1) is connected to each electrode 20 via a lead wire (not shown).

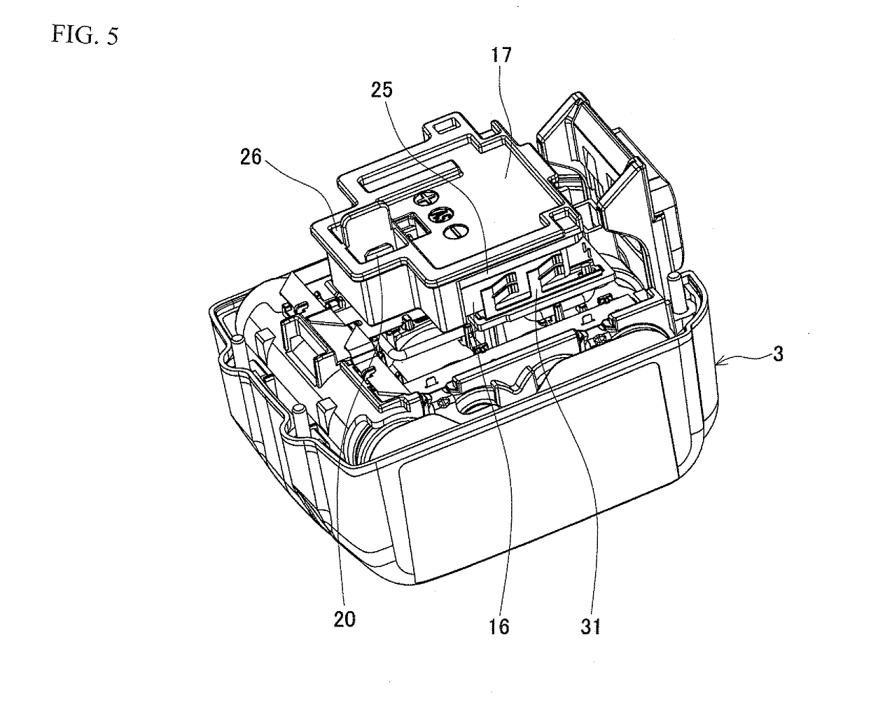

The slide rails 15, 15 (see FIGS. 1 and 2) extending in the longitudinal direction are formed at left and right ends of the battery pack 3. Charging/discharging terminals 31, 31 (see FIG. 5) are placed between the slide rails 15, 15 in the battery pack 3 at the same interval as that between the terminal plates 16, 16. As shown in FIG, 2, slits 32, 32 extending in the longitudinal direction are formed in an upper surface of the battery pack 3 at the same interval as that between the charging/discharging terminals 31, 31. Each of the charging/discharging terminals 31 faces the inside of a corresponding one of the slits 32.

When the battery pack 3 is mounted on the battery holding portion 7, the slide rails 15, 15 of the battery pack 3 shown in FIG. 2 are slid along the left and right guide rails of the battery holding portion 7. Accordingly, the guide rails hold the slide rails 15 therebetween, so that the battery pack 3 is mounted on the battery holding portion 7. Further, as shown in FIGS. 1 and 5, the terminal plates 16, 16 enter the slits 32, 32, and thus are slid and inserted into the charging/discharging terminals 31, 31. Accordingly, the terminal plates 16, 16 are electrically connected to the charging/discharging terminals 31, 31. By pressing the trigger 11 shown in FIG. 1 into the handle portion 6, the switch 12 is turned on, thereby the battery pack 3 supplies electric power to the motor 3.

For example, when a screw is tightened into a block of wood by the tool mounted on the socket holding portion 10, vibrations are produced by the impact during operation of the impact driver 1. Such vibrations are continuously transmitted from the main body housing 2 to the terminal plates 16, 16 through the terminal base 17. If the terminal plates 16, 16 are thus continuously vibrated, the terminal plates 16, 16 rub against the charging/discharging terminals 31, 31, thereby causing melting of the terminal plates 16, 16. In order to prevent such a disadvantage, in the present embodiment, vibrations are absorbed by the buffer members 25 interposed between the terminal base 17 and the terminal plates 16, 16 and between the terminal base 17 and the arm members 19, 19, so that vibrations are less likely to be transmitted to the terminal plates 16, 16. This can suppress rubbing of the terminal plates 16, 16 against the charging/discharging terminals 31, 31. Moreover, in order to suppress transmission of vibrations to the terminal plates 16, 16, the buffer members 25 described above needs only to be formed on the terminal base 17, and no additional processing is required for the charging/discharging terminals 31. This can simplify the structure of the charging/discharging terminals 31.

### Effects of Embodiment

According to the impact driver 1 of the present embodiment, even if vibrations produced during operation of the impact driver 1 are transmitted to the main body housing 2, the buffer members 25 made of the elastomer can suppress transmission of the vibrations from the terminal base 17 to the terminal plates 16, 16. This can suppress rubbing of the terminal plates 16, 16 against the charging/discharging terminals 31, 31 of the battery pack 3, and thus can suppress melting of the terminal plates 16, 16. Moreover, it can be realized to suppress melting of the terminal plate only by the buffer member 25 interposed at least between the terminal base 17 and the terminal plates 16, 16, and between the terminal base 17 and the arm members 19, 19. Therefore, the structure that suppresses melting of the terminal plates 16, 16 can be inexpensively and easily implemented.

The buffer members 25 made of the elastomer is held between the terminal base 17 and the terminal plates 16, 16 with the through holes 18 in the terminal plates 16, 16 being filled with the elastomer. This can increase the strength in integrating each terminal plate 16 with the buffer member 25. Moreover, the buffer members 25 are held between the terminal base 17 and the arm members 19, 19 with the through holes 18 in the arm members 19, 19 being filled with the elastomer. This can increase the strength in integrating each arm member 19 with the buffer member 25.

The present invention is not limited to the above embodiment, and the configuration can be partially changed as appropriate without departing from the spirit and scope of the invention. The above embodiment is described with respect to an example in which the buffer members 25 are made of the elastomer. However, the buffer members may be made of a fluorine-containing rubber having high heat resistance. The above embodiment is described with respect to an example in which the terminal plates 16, 16 and the arm members 19, 19 are attached to the lower surface of the terminal base 17 with the buffer members 25 interposed between the lower surface of the terminal base 17 and the terminal plates 16, 16 and between the lower surface of the terminal base 17 and the arm members 19, 19. However, the terminal plates 16, 16 may be attached to the lower surface of the terminal base 17 with the buffer members 25 interposed therebetween, and no buffer member 25 may be provided between the lower surface of the terminal base 17 and the arm members 19, 19. The above embodiment is described with respect to an example in which the present invention is applied to an impact driver. However, the present invention is not limited to this, and the present invention may be applied to an electric power tool such as a rechargeable drill driver in which a terminal plate is slid and mounted on a battery pack.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An electric power tool, comprising:
a battery holding portion formed in a housing;
a terminal base provided in the battery holding portion and having a terminal plate attached thereto;
a battery pack on which the terminal plate is slid and mounted; and
a buffer material interposed at least between the terminal base and the terminal plate.

2. The electric power tool according to claim 1, wherein
a through hole is formed in the terminal plate, and the terminal plate is attached to the terminal base with the through hole being filled with the buffer material.

3. The electric power tool according to claim 2, wherein
the terminal plate has a rectangular shape having a shorter side in a vertical direction and a longer side in a longitudinal direction, and
a plurality of the through holes arranged in the longitudinal direction is formed in an upper part of the terminal plate.

4. The electric power tool according to claim 3, wherein
a pair of the terminal plates is placed such that the terminal plates are parallel to each other below the terminal base, separated from each other, and face each other in a lateral direction.

5. The electric power tool according to claim 4, wherein
a buffer member made of the buffer material is formed integrally with inner and outer surfaces of an upper end and an upper surface portion of each of the terminal plates with the through holes in the terminal plate being filled with the buffer material.

6. The electric power tool according to claim 5, wherein
an electrode extending in the vertical direction is connected to a rear end of the terminal plate via an arm member extending in the lateral direction, and a through hole is formed in a central portion of the arm member and a lower end of the electrode, and
the buffer member is formed integrally with an outer surface of the arm member and the lower end and a lower surface portion of the electrode with both the through hole in the arm member and the through hole in the electrode being filled with the buffer material.

7. The electric power tool according to claim 6, wherein
the buffer member is formed continuously and integrally with the inner and outer surfaces and the upper surface portion of the terminal plate, the outer surface of the arm member, and the lower end and the lower surface portion of the electrode.

8. The electric power tool according to claim 6, wherein
an electrode accommodating space, which opens in an upper surface of the terminal base to accommodate the electrode, is provided in the terminal base.

9. The electric power tool according to claim 1, wherein
the buffer material is an elastomer or a fluorine-containing rubber.
